(19) United States
(12) Patent Application Publication
(10) Pub. No.: US 2021/0117614 A1
(43) Pub. Date: Apr. 22, 2021

(54) One click listing

(71) Applicant: Kenley Jacques Lamaute, Sammamish, WA (US)

(72) Inventor: Kenley Jacques Lamaute, Sammamish, WA (US)

(21) Appl. No.: 16/556,232

(22) Filed: Aug. 30, 2019

(51) Int. Cl. G06F 40/174; G06F 16/93; G06F 16/955

(52) U.S. Cl. CPC G06F 40/174; G06F 16/955; G06F 16/94

(57) ABSTRACT

The present invention discloses an advance system for gathering information from different sources to be used to automatically fill in online forms. The system includes links that are embedded within the form and a single click will activate the links which will be analyzed by a web application on the destination web server to extract the parameters in the URL. The extracted parameters are then used to fill out form details on behalf of the user.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates generally to computer software for filling out form documents over a computer network. More specifically, the present invention provides a method and system for automatically filling out fields in an electronic form document on a browser program.

### Description of the Related Art

Rapid growth and technological advances have changed the way most people currently use computers. During the early days of computers, a paradigm existed whereby there were more computer users than computers, and thus most computers had many assigned or dedicated users. As technology progressed, the personal computer (“PC”) emerged, and it became commonplace for many computers to have only one user. Subsequent growth, particularly in the 1990s, has seen a culture or paradigm emerge whereby a computer user has access to more than one computer. As such, many individuals now have substantial access to multiple computers, for example at workplaces, schools, libraries, homes, and while traveling. This ratio of available computers per computer user should increase even further over time. It is therefore increasingly desirable to have computer-based programs and services that are accessible to a particular user from any computer, and not just those computers that have been programmed or adapted for that particular user.

One result of the recent explosion in computer growth is the amount of communication that now takes place between separate computers or computer systems. Many methods and systems exist for communications between computers or computer systems. This is reflected in many contexts, such as in the growth of the Internet. For purposes of the following discussion, several methods and systems will be described with reference to the Internet as a matter of convenience. It should be understood, however, that this is not intended to limit the scope of this discussion, and that many other applicable devices and protocols for computer communications exist, such as “Intranets”, closed proxy networks, enterprise-wide networks, direct modem to modem connections, etc.

Exchange of information between computers in an electronic communication system is now commonplace. Users of e-commerce via the Internet often encounter situations where forms are required to be completed. Electronic commerce involves commercial activities between businesses, as well as between consumers and businesses that involve electronic media operating under a standard payment platform, such as electronic payment systems and online banking systems.

There are multiple systems that have been proposed in prior art regarding automatic filling of information in user forms. For instance a method for online information sharing for completing electronic forms bearing U.S. Pat. No. 7,334,184B1 is issued to Callahan Cellular LLC, Liberty Peak Ventures LLC , Callahan Cellular LLC, Liberty Peak Ventures LLC. The patent discloses a method for gathering information from different sources to be used to automatically fill in online forms. The information is collected using a persona of an individual. A persona is created by filtering a larger set of raw data for that user so that only certain fields are allowed to be seen and used by others.

An individual can have several personas, each assigned to a particular other individual, such as a family member or a friend. The individual allowing one of his personas to be shared is the information provider and the user requesting the information is the information requester. The information is taken from both the provider and requester, and used by a vendor in a form, filled out by the information requester. In one embodiment, the information requester is a “gift giver” and the provider is a “gift receiver.” The gift giver is requesting shipping and other information from the gift receiver, who can grant one of his personas to the particular gift giver. The information, along with billing information from the gift giver, is used to fill out a vendor online form.

A Server for enabling the automatic insertion of data into electronic forms on a user computer bearing U.S. Pat. No. 6,490,601B1 is issued to Liberty Peak Ventures LLC, Liberty Peak Ventures LLC. The patent discloses apparatus, methods, and computer program products are disclosed for constructing and transmitting an executable software module on a personal information server to a remote computer. The software module is constructed such that once received by a browser displaying a form, it is executed and user data is automatically inserted into an electronic form. The software module contains field names from a downloaded form and matching data items which are inserted into the form on the remote user computer. A method for constructing a shippable software module on a personal information server suitable for execution on a remote computer for inserting data strings into an electronic form is described. A form mapping containing a set of associations between fields in the electronic form (“non-standard fields”) and pre-named fields (“standard fields”) on the personal information server is retrieved. Each mapping is associated with a registered electronic form. A raw data file containing data strings, each data string corresponding to a pre-named field is retrieved. Each raw data file is associated with a registered user. The form mapping is utilized to attach a data string to the field in the electronic form where the pre-named field and the field in the electronic form have been previously matched or mapped.

An Electronic form automation system bearing U.S. Pat. No. 9,069,745B2 is issued to PayPal Inc, PayPal Inc. The patent discloses some embodiments may provide a method comprising receiving, from a remote machine, entity-identifying data and form identifying data, the form identifying data to identify a sequence of one or more electronic forms, the sequence including a target electronic form having a form element, determining an entity identifier, based on the entity-identifying data, accessing, from a data store, an entity attribute value based on the entity identifier, and transmitting, to the remote machine, form-filling instructions operable to cause a machine to automatically associate an entity attribute value with the form element.

An Assisted form filling bearing U.S. Pat. No. 7,426,496B2 is issued to Zhigu Holdings Ltd., Zhigu Holdings Ltd. The patent discloses systems and methods are described that facilitate assisting a user in filling forms. The invention can parse untagged media, such as email, etc., to identify elements that can be employed to populate a form. Identified elements can be automatically inserted into corresponding fields in a form, and status indicators can be associated therewith and indicated to a user in order to alert the user that review of a particular field in the form is warranted. Additionally, the untagged media and the form can be concurrently presented to the user to facilitate user supervision and/or interaction during assisted form filling.

An Automated support scheme for electronic forms bearing U.S. Pat. No. 8,095,476B2 is issued to Oracle OTC Subsidiary LLC , Oracle OTC Subsidiary LLC. The patent discloses actions associated with entering information into different fields of an electronic form are monitored. The types of support provided for entering the information into the different fields can be dynamically varied according to monitored user actions or according to the context or categories of users, fields, or forms. Different types of query or search engines can be used to further identify the context, intent, or meaning of information entered into the different fields. The identified context, intents, or meanings are then used to provide further on-line support. Other analytics of both field entries and user actions can also be used to provide addition help when entering information into the on-line forms.

A Customer service electronic form generating system bearing U.S. Pat. No. 5,774,887A is issued to Qwest Communications International Inc, Qwest Communications International Inc. The patent discloses an apparatus for producing a series of electronic forms that are related to completing a task. The apparatus includes a computer system in which one or more databases are stored. The computer system displays a list of tasks that can be selected by a customer service representative. Each task has associated with it a series of forms that must be completed. Each form includes a plurality of fields, each of which has an associated database. A code segment associated with each field processes data as it is entered into the field and stores the data in the field's associated database. The system also provides a task map indicating the forms that must be completed to finish a given task, as well as the forms that have already been completed.

A Computerized system for automated completion of forms bearing U.S. Pat. No. 7,203,699B2 is issued to Robert E. Bellamy, Robert E. Bellamy. The patent discloses a computerized system for automated completion of forms is an Internet accessible system for automatically completing forms such as employment or other applications from individual user data retained in a database. The computerized system for automated completion of forms provides for conversion of a paper application form into an electronic form image that is then mapped to identify entry fields, define electronic entry fields associated with the entry fields on the paper form, and associate the electronic entry fields with data item definitions in the database for automatic filling of the form fields form data stored in the database. Users may enter their personal data into the database for subsequent filling of forms either through a default data entry process, or by filling out a first form.

A Method and apparatus for populating electronic forms from scanned documents bearing Korean patent 1,011,22854B1 is issued to Korean inventor. The patent discloses a computer filling the electronic form from an electronic image-implemented method and apparatus are provided. The method and apparatus identifies the size, orientation, and location of the object in the electronic image, and identifies the information element from the pixels in the image corresponding to the object. Field of electronic forms are displayed to the user along with information elements identified through a graphical user interface. Information elements are parsed into a tag attached to a group of different types of information. At least some of the electronic format of the field generates a populated template filled with tags attached to the group. Users can be edited via the graphical user interface, the filled fields.

U.S. Pat. No. 6,065,048, entitled “Method and System to Create, Transmit, Receive and Process Information, Including an Address to Further Information,” describes a method and system for sending and receiving Uniform Resource Locators (URLs) in electronic mail over the Internet. U.S. Pat. No. 6,004,205 entitled, “Communication System for Transferring Information Between Memories According to Processes Transferred with the Information,” describes an automated communications system that operates to transfer data, metadata and methods from a provider computer to a consumer computer through a communications network. U.S. Pat. No. 6,026,410, entitled “Information Organization and Collaboration Tool for Processing Notes and Action Requests in Computer Systems,” describes a natural language-based information organization and collaboration tool for a computer system. U.S. Pat. No. 6,018,761, entitled “System for Adding to Electronic Mail Messages Information Obtained From Sources External to the Electronic Mail Transport Process,” discloses an apparatus and method for obtaining message context information regardless of whether or not the sender includes context information, such as a full name, address or telephone number. U.S. Pat. No. 6,012,083, entitled “Method and Apparatus for Document Processing Using Agents to Process Transactions Created Based on Document Content,” discloses a Web agency being interposed between a Web client and a Web server to transform the requests from the Web client prior to sending the requests to the Web server, as well as other steps or structures as described by said patent.

Another Method and apparatus for creating and filing forms bearing U.S. Pat. No. 8,984,393B2 is issued to Aatrix Software Inc., Aatrix Software Inc. The patent discloses a method for designing, creating, and importing, on a digital computer having a memory and a processor executing a stored program, data into a viewable form viewable by the user of a data processing system, the viewable form duplicating the paper form, comprising the steps of: executing the stored program to convert the paper form into a viewable image that duplicates the paper form, the viewable image having a data field for receiving data; importing data into the data field; performing calculations on the imported data in the data field; allowing the user to review and change the data; and printing and/or electronic filing the viewable form.

It has to be noted that the current invention proposes an advancement in providing a sophisticated solution for filling the electronic forms automatically. The proposed system allows one click listing without requiring users to fill out a form manually. The links can be embedded in web pages that are pre-populated to perform an action and submit a listing on the online marketplace. Once the user starts filling, on a click the majority of marketplace details will be pre-filled for the specific topic. The proposed system works with parameters being included in a web URI that are embedded in content as a hyperlink. This hyperlink, when clicked is parsed by a web application on the destination web server to extract the parameters in the URL. The extracted parameters are then used to fill out form details on behalf of the user.

None of the previous inventions and patents, taken either singly or in combination, is seen to describe the given invention as claimed. Hence, the inventor of the present invention proposes to resolve and surmount existent technical documentation to eliminate the aforementioned shortcomings of prior art.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is an exemplary illustration of the login page.

FIG. 2 is an exemplary illustration of the desired projects page.

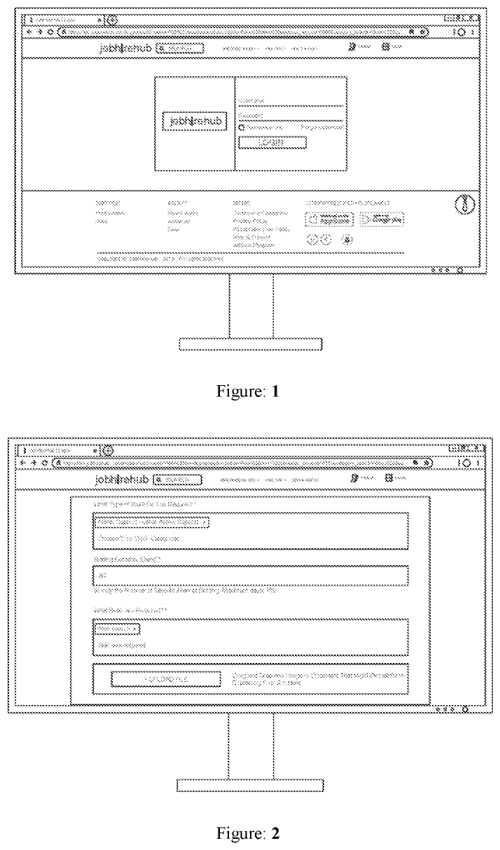

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of automatic filling of forms that allows instant filling of information without much of user input.

It is the most important objective of the invention is to provide a one click listing without requiring users to fill out a form.

It is also the objective of the invention to provide embedded links in web pages that are pre-populated to perform an action and submit a listing on the online marketplace.

It is another objective of the invention to provide an ease of use and one click filling of forms to save users time.

It is further the objective of the invention to provide an ease of use for the user where the links are embedded within the webpage and activated on one click.

It is also the object of the present invention to provide an automatic filling of form which can be useful for any type of industry.

A further object is to provide an application that is simple and easy to use interface for the user.

It is also the objective of the invention to provide compatibility on a wide range of form factors such as mobile phone, tablets and desktop computers.

Still yet another object of the present invention is to provide a new and improved automatic insertion of data in forms which provides in the apparatuses and methods of the prior art some of the advantages thereof, while simultaneously overcoming some of the disadvantages normally associated therein.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The current system proposes a method and apparatus providing for improved automation for entry of data in forms displayed on a screen via a web browser.

The present invention is a technique use to gather information from different sources to be used to automatically fill in online forms. The information is collected using a persona of an individual. A personal space is created by filtering a larger set of raw data for that user so that only certain fields are allowed to be seen and used by others. An individual can have several options and user can select the information as per their likeness.

The system as per its preferred embodiments allows one click posting to a marketplace that pre-fills form details and can be used in web content or bots. The online marketplaces can get a listing posted on their platform with one click. It is constructed with a URL builder that passes parameters as part of the hyperlink to create the listing.

As per further embodiments, user responses in the bot construct a URL that directs the users to the marketplace destination and creates the listing for them (even signs them into the marketplace if necessary)

The links as per further embodiments can be embedded in web pages that are pre-populated to perform an action and submit a listing on the online marketplace, once clicked the majority of the form details will be pre-filled for the specific topic

The system as per its further embodiments works with parameters being included in a web URI that are embedded in content as a hyperlink. This hyperlink, when clicked is parsed by a web application on the destination web server to extract the parameters in the URL. The extracted parameters are then used to fill out form details on behalf of the user.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: Comprises of a communication system for filling out an electronic form based on an automatic data filling standard comprising:
a) a simple form interface presented to user;
b) links embedded within written page content and pre-populated to perform an action;
c) one click enabling the hyperlinks;
d) allows automatic data filling and submission of form.

II: Comprises of an online data filling system for e-forms where the complex algorithms of the system work with parameters being included in a web URI that are embedded in content as a hyperlink. The hyperlink once clicked is analyzed by a web application on the destination web server to extract the parameters in the URL. The extracted parameters are then used to fill out form details on behalf of the user.
